(19) United States
(12) Patent Application Publication
(10) Pub. No.: US 2003/0014256 A1
(43) Pub. Date: Jan. 16, 2003

(54) Playback unit and method of providing information to prospective automobile purchasers

(76) Inventors: Marmon Pine, Deerfield, IL (US); Donald S. Pine, Glendale, AZ (US)

Correspondence Address: Jeffrey A. Pine, BANIAK PINE & GANNON, Suite 1200, 150 N. Wacker Drive, Chicago, IL, 60606, US

(21) Appl. No.: 10/207,326

(22) Filed: Jul. 29, 2002

Related U.S. Application Data
(63) Continuation-in-part of application No. 09/141,678, filed on Aug. 27, 1998, now abandoned.
Application No. 09/141,678 is a continuation of application No. 08/387,491, filed on Feb. 9, 1995, now Pat. No. 5,802,100.

(51) Int. Cl. G10L 21/00

(52) U.S. Cl. 704/270

(57) ABSTRACT

The present invention discloses a playback unit and method for obtaining contact information from prospective purchasers pertaining to an automobile for sale. The playback unit allows prospective purchasers to leave contact information which is transmitted to the automobile dealer. Further, the playback unit incorporates a GPS system to provide location information to the dealer.

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

Attached herewith as a Microfiche Appendix is a microfiche of 196 pages of the computer program listings of the present invention. The Microfiche Appendix contains 3 frames.

### BACKGROUND OF THE INVENTION

The present invention relates to a method and apparatus for collecting, organizing and transmitting information and more particularly, for providing information pertaining to an automobile for sale to prospective purchasers.

For most people, an automobile is one of the largest single purchases they will make. In order to choose the right automobile, however, the prospective purchaser must obtain information on the automobile being sold. Information pertaining to previously driven or used automobiles, such as miles previously driven, will vary even for similar model automobiles manufactured in the same year. The varying information makes the automobile for sale more or less attractive to the prospective purchaser and determines the automobile value. In most cases, to obtain this information a prospective purchaser must visit an automobile dealership and ask the salesperson specific questions pertaining to the automobile for sale.

A visit to an automobile dealership can be a tension-filled activity for the prospective purchaser. Prospective purchasers tend to distrust automobile salespeople. Much of the distrust emanates from warnings, sometimes from consumer advocate groups, which warn shoppers that the sales pitch or message pertaining to the automobile may change depending on the gender, race, age, etc. of the purchaser.

Smart automobile dealers exploit this fact by advertising that their dealership uses a low-pressure shopping environment. Shoppers can view automobiles at the dealership and ask questions without encountering a pushy salesperson. This is also known as “hassle-free looking.” The salesperson will not initiate contact unless requested by the prospective purchaser. In fact, some dealers provide the prospective purchaser with a pin which says “I am just looking”, promising that as long as they wear the pin, they will not be approached by a salesperson. Other dealers claim that they do not employ salespeople, only information specialists.

This approach seems to fit the times. Unfortunately, in the matter of automobiles, information on the specifics of a particular car is just not available without asking a salesperson. It is also not readily available outside of normal business hours. In fact, a prospective purchaser wandering a used car lot may have questions on many cars of interest.

A dealer may spend hundreds of dollars per car trying to answer some of these questions through conventional advertising. Further, print and broadcast media, complimented by direct mail, attempt to attract buyers with leading details of particular cars.

### SUMMARY OF THE INVENTION

An audio playback unit and method for assembling and providing information pertaining to an automobile for sale to prospective purchasers is disclosed. The playback unit is tamperproof, weatherproof and theftproof, allowing it to survive the environment of the automobile dealer. It is also portable, allowing it to be placed in an automobile for sale, and easy for any prospective purchaser to use. The prospective purchaser activates the playback unit by depressing a button located on the control panel which is attached to a window of the automobile. Once activated, the playback unit transmits, through a speaker located on the control panel, a message to the prospective purchaser pertaining to the automobile for sale.

The message transmitted by the playback unit can be easily and reliably changed by the automobile dealer. Changing the message merely requires the dealer to remove a replaceable memory from the playback unit and insert into the playback unit a new replaceable memory containing a message pertaining to a second automobile. Due to the portable nature of the playback unit, a dealer can place the playback unit in the second automobile once the first automobile is sold. Once activated, the playback unit will transmit the message pertaining to the second automobile.

The replaceable memories can be programmed with new information at a service center. In order to program the new message into the replaceable memory, an automobile dealer transmits information pertaining to an automobile to be sold to the service center. The service center operator converts the received information into new message information. The operator downloads the new message information into the new replaceable memory and transfers the new replaceable memory back to the dealer. The dealer places the new replaceable memory into the playback unit and places the playback unit into the automobile for sale. A prospective purchaser can hear the new message pertaining to that automobile by activating a switch on the control panel.

Along with the message pertaining to the automobile for sale, a dealer can direct the service center to add additional information to transmit to a prospective purchaser. Therefore, a dealer can advertise to prospective purchasers their dealership, any special offers, or even sell the available advertising space.

The present invention further utilizes an automated method to select and organize speech elements whereby information to be spoken by the playback unit may originate either in the replaceable memory or in non-replaceable memory located in the playback unit.

The present invention further utilizes an automated method to collect contact information, such as name and phone number, from any prospective purchaser. When a prospective purchaser visits the automobile car lot for example when the car lot is closed, as is often the case, the dealer will know who was interested in information on a particular vehicle. This information, particularly useful for sales and marketing purposes, can be collected in many ways such as by a microphone (voice message), keypad or other automated recording means, all located within the playback unit and passed along to the dealer's receiving system for example by a wireless communication link also located in the playback unit.

The dealer is able to identify which automobile sent the message because also contained in the message is a code which uniquely identifies either the particular vehicle or playback unit (or both) which is sending the message. This code is referred to herein as the Unique Identifier Code (UIC). The UIC is generated within the playback unit by scanning or keying into the playback unit the Vehicle Identification Number (VIN), permanently assigned to and encoded on each vehicle by the vehicle manufacturer when the vehicle is manufactured, or by using a serial number type code (S/N) programmed into each playback unit during manufacture. As will be seen in further discussion, the VIN, the S/N or both can be used to generate the UIC. The dealer or an outside service maintains an index which links each UIC to the playback unit and to the automobile on which it is mounted.

Another problem troubling the automobile dealer is that of keeping track of where, on the car lot, a particular vehicle may be parked. These vehicles are continuously driven on “demo” rides by prospective purchasers, moved for maintenance purposes or driven home by employees. A large dealership may have as many as 500 vehicles or more, many of them being moved around at any one time. Dealerships presently deal with this problem by mandating that cars be parked in predetermined locations, or that keys be stored in special ways, or that employees enter into computer files the last known location of vehicles, and the like. These schemes are all variations of manual methods, and over the years of using them, they have been shown to work poorly, at best. As a result, much time and cost is expended, daily, locating vehicles.

The present invention solves this problem by enabling the playback unit, which is mounted on the vehicle, to report its own current location. This is accomplished by incorporating a Global Positioning System (GPS) in the playback unit. The GPS system works by electronically determining its own location using signals continuously broadcast from a series of 24 orbiting satellites.

In the present invention, the location data from the GPS is monitored by the playback unit microprocessor and, in a similar fashion as the wireless transmission described above, a message containing this location data is transmitted from the playback unit to the dealer's receiving system. This “location” message tells the dealer whether or not the vehicle is on the car lot, and, approximately, where to locate it.

Of course, location information can be used for additional purposes. For example, location information reveals the activity pattern for any such playback unit equipped vehicle, providing information which the dealer can use for sales and financing decisions. Also, when the dealership is closed, the present invention's location message can be used to alert security personnel that a vehicle is changing its location, or, in another security use, if a location message is not received when expected, an alert is sounded.

These examples are but a few of the many ways that the wireless communication link of the present invention effectively connects that vehicle with the outside and allows the dealer to monitor and use information relating to any vehicle equipped with the playback unit of the present invention.

As a matter of sales procedure, the automobile dealer's sales manager would like to assign a salesperson to cover any prospective purchaser on the car lot. However, since the automobile dealer may have several hundred automobiles for sale parked throughout the car lot, and since prospective purchasers may enter the car lot without first checking in at the showroom, the dealer's sales manager usually does not know when a prospect is wandering around the car lot. To solve this problem, when the prospective purchaser activates the control switch on an APU as disclosed above to receive a message, the playback unit automatically sends a message to the dealer's receiving system informing the sales manager that a message is in progress, i.e., a prospective purchaser is present at the vehicle. Upon receiving this “prospect-is-present” (PIP) message, the sales manager can dispatch a salesperson to the particular automobile to engage the prospect in sales activity.

As described previously, when the prospective purchaser wishes to receive a message about an automobile, he activates the control switch mounted on the control panel. The methods of message delivery to the prospective purchaser may include, among others, audio output, image output on a visible display screen located on the control panel, and various other delivery messages.

The message delivered by the display screen can be, but need not be, similar in content to the previously described audio message. The display message type additionally supports a broader range of message content than the audio message type. For example, the message displayed to the prospective purchaser may originate at a remote location, such as an Internet Site or dedicated Network Server. To access remote sites automatically, the playback unit translates the UIC to create a remote address, such as an Internet URL, and then using the Wireless Communication Link, also described above, the playback unit requests, downloads and then displays information from the addressed site. The resulting display can resemble a page from a Website, or it can contain animation similar to that found on a conventional television screen or it can present specialized vehicle information prepared and stored especially for this purpose. The downloading process can occur when the message is requested or at other times either manually or automatically. For example, a manual download may occur when the audio playback unit is first placed on the automobile to be sold. Further, the system may automatically download the message every day or hour to make sure the correct and updated message has been downloaded into the unit.

Other advantages and benefits of the present invention will become known to the artisan through study of the following descriptions, the attached drawings, the instructions found in the Appendix, and the definitions and claims which follow.

### BRIEF DESCRIPTION OF THE DRAWINGS

Preferred embodiments of the invention are explained below with references to the accompanying drawings in which:

FIG. 1 illustrates the preferred embodiment of the audio playback unit according to the present invention.

FIGS. 2A, 2B, 2C and 2D illustrate a schematic of the audio playback unit according to the present invention.

FIG. 3 illustrates a functional block diagram of the audio playback unit according to the present invention.

FIG. 4 illustrates a functional block diagram of the internal memory download routine according to the present invention.

FIG. 5 illustrates a functional block diagram of the external memory download routine according to the present invention.

FIG. 6 illustrates a representation of the internal and external memory storage devices according to the present invention.

FIG. 7 illustrates a functional block diagram of an alternative embodiment.

FIG. 8 illustrates the preferred embodiment of the Outbound Message Format.

FIG. 9 illustrates an alternative embodiment of a system for transmitting information about an automobile for sale.

### DETAILED DESCRIPTION OF THE PREFERRED EMBODIMENT

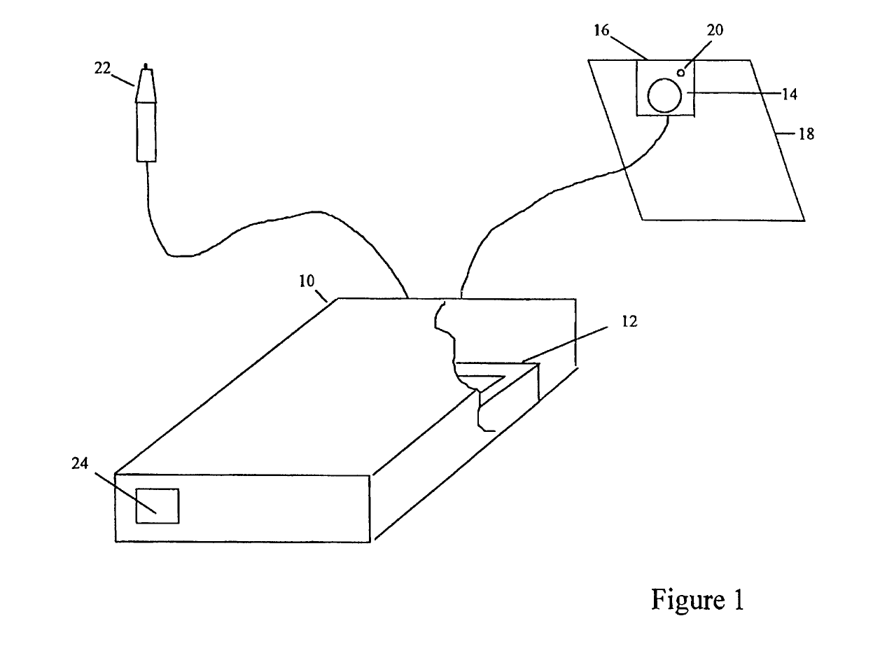

FIG. 1 illustrates an audio playback unit 10 according to a preferred embodiment of the present invention. The playback unit 10 is used to transmit information pertaining to an automobile to be sold to prospective purchasers. The playback unit is placed in an automobile to be sold, the transmitted information pertains to that automobile for sale.

The playback unit 10 includes a printed circuit board 12 which controls the message to be transmitted. The playback unit 10 transmits the message through a speaker 14 attached to a control panel 16 when the control or switch 20, also attached to the control panel 16, is activated. While the playback unit is placed inside the automobile, the control panel 16 is placed on the automobile window 18 such that the control 20 and speaker 14 rest outside of the automobile window 18. In this manner, a prospective purchaser can control the playback unit 10 and listen to the message transmitted through the speaker without entering the automobile.

The control 20 is a single push-button switch that, when activated, will begin the audio transmission of the message pertaining to the automobile to be sold. The control 20 can also be used such that if the switch is activated during the message transmission, the program will “back up” a determined period of time, for example, ten seconds, or a predetermined number of speech elements, and begin transmitting the message from that point, a ten second review. This capability will enable the prospective purchaser to immediately review relevant information. Another use of the control panel is a switch to transmit the message in either English or Spanish.

The control panel 16 is placed on the window 18 of the automobile such that the window 18 can close tightly and keep rain and snow out of the automobile and thus protect the inside of the automobile from the elements. This aspect of protecting the inside of the automobile is especially necessary because the automobiles are washed frequently with high pressure water hoses. The speaker 14 and control 20 must be able to withstand rain, snow, wind, and water delivered at high pressure.

The playback unit is powered from the automobile battery via a power plug 22 inserted into the automobile cigarette lighter. Although using the automobile battery is the preferred embodiment, in another embodiment, the audio playback unit 10 can be powered by an internal battery (not shown).

To protect the external memory from tampering, an external memory insertion slot 24, on the front of the playback unit 10, is used for the insertion and removal of the replaceable memory. While the external memory can be inserted and removed from the external memory insertion slot 24 using an insertion tool (not shown), the prospective purchaser cannot remove the replaceable memory without the insertion device. The use of the insertion slot 24 minimizes theft and tampering of the replaceable memory.

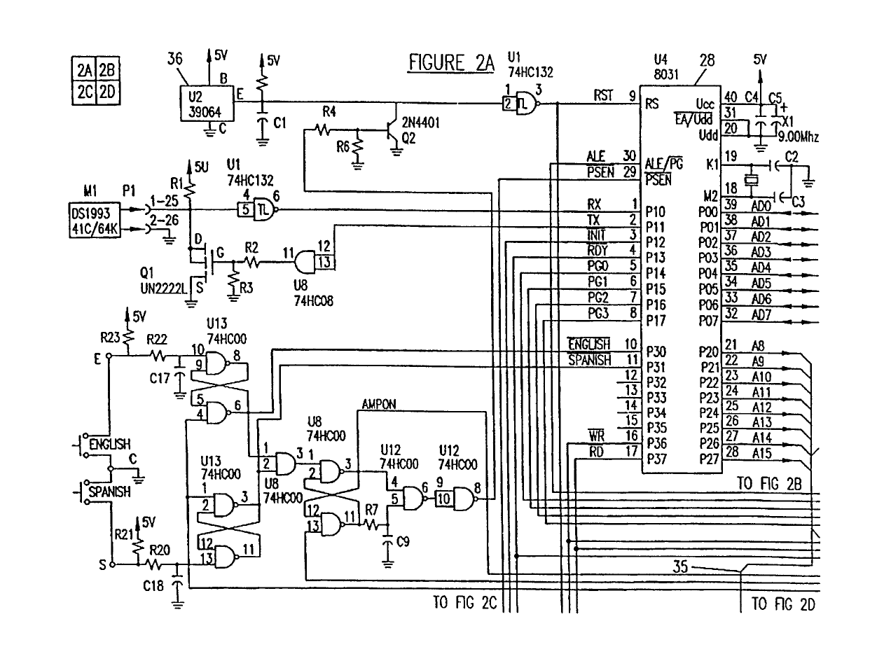

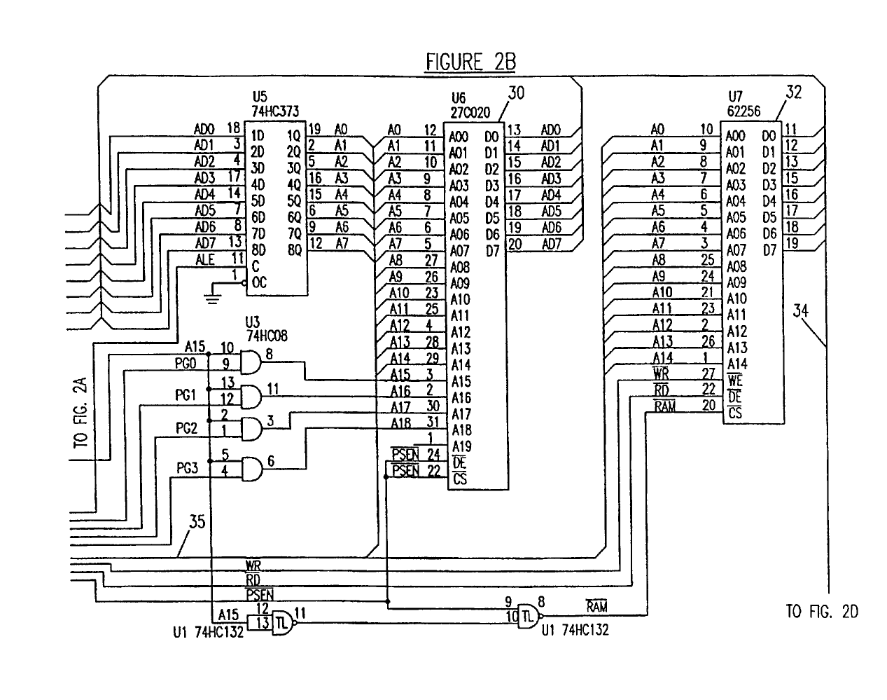

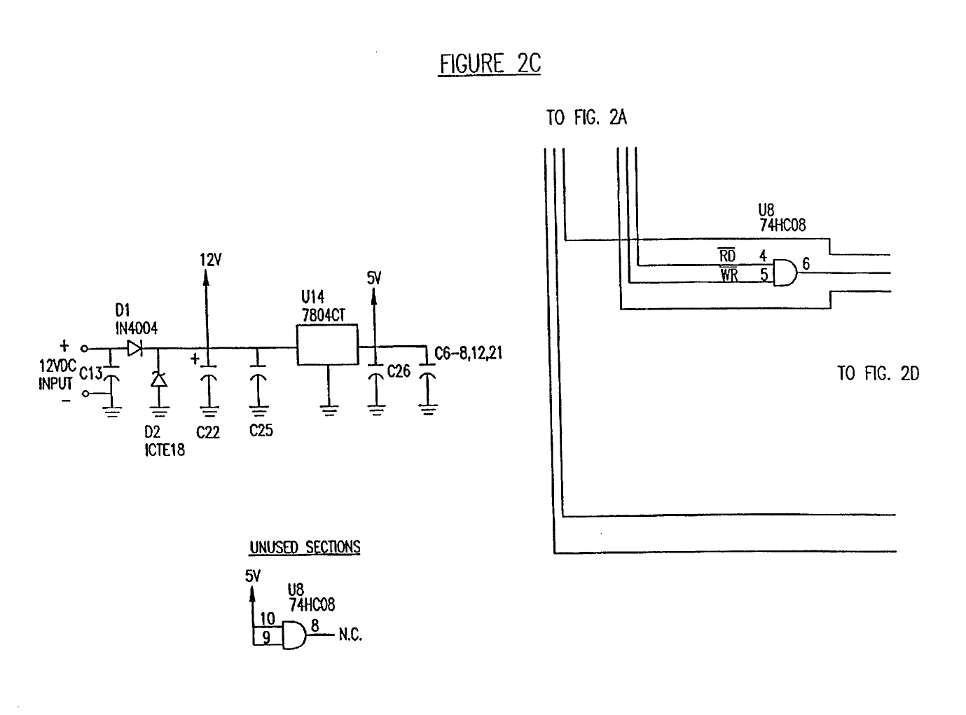

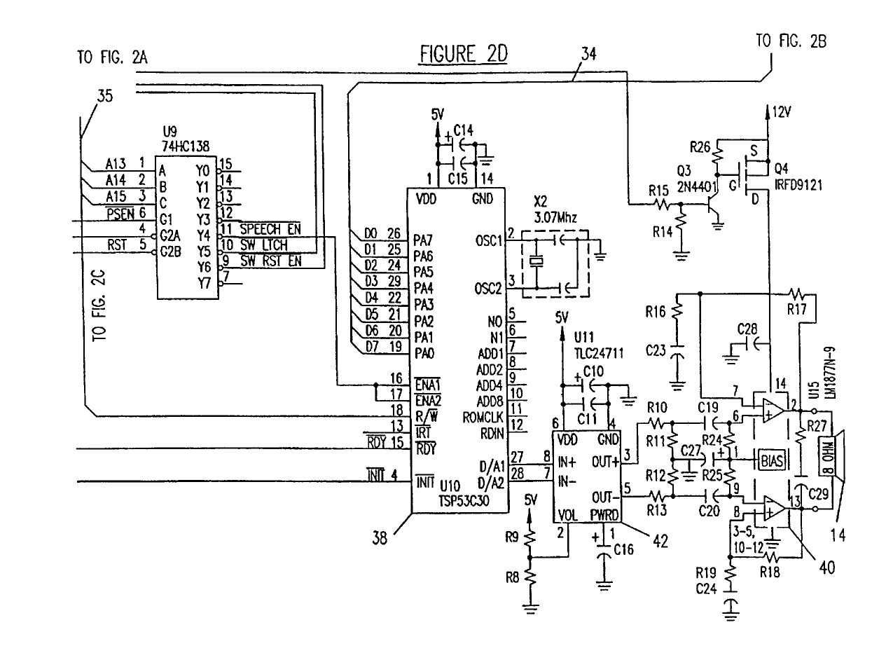

FIGS. 2A, 2B, 2C, and 2D illustrate the electrical schematic describing the printed circuit board 12 located inside of the playback unit 10. Located on the printed circuit board 12 is a microprocessor U4 28 which controls all aspects of the audio playback unit 10. The microprocessor 28 utilized in the preferred embodiment is an Intel 8031 microprocessor. The microprocessor 28 is controlled by a microprocessor program which, along with certain data used in the program, is stored in a memory storage device. The playback routine used by the microprocessor 28, among other things, reads the replaceable memory, assembles the elements in a random access memory, and controls the transmission of the message. The microprocessor program is attached as part of Microfiche Appendix.

Also located on the printed circuit board 12 are two types of memory storage devices which are utilized by the microprocessor 28 in controlling the audio playback unit 10. The first type of memory, internal, is the main erasable programmable read-only memory (EPROM) U6 30 which contains the program to control the microprocessor 28 and also contains stored speech elements used to create the message to be transmitted to the prospective purchaser. In the preferred embodiment, the audio playback unit utilizes a 256K×8 EPROM (27C020). The internal memory also includes a random access memory U7 (RAM) 32, which is utilized by the microprocessor 28 when creating the message to be transmitted. The preferred embodiment utilizes a 32K×8 RAM (62256).

The microprocessor 28 is electrically coupled to the internal memory devices 30 and 32, and to a speech processor U10 38, through the data bus 34 (the microprocessor 28 also utilizes the data bus 34 as an address bus for certain applications). The microprocessor 28 also utilizes an address bus 35 to control the internal memory devices 30 and 32, and the speech processor 38.

Although not used in the preferred embodiment, the internal memory may also utilize one or more auxiliary memories. An auxiliary memory may be used to increase the internal memory storage space, for example, when it becomes necessary to install additional dealer specific elements or advertising, or to store elements in another language, such as Spanish.

The second type of memory is the replaceable memory or external memory M1 36. The external memory 36, which is easily inserted or removed from the playback unit 10 through the external memory insertion slot 24 using an insertion tool, contains data identifying location, in internal memory 30, of speech elements used by the microprocessor 28 when creating the message to be transmitted, or may contain the speech elements themselves. The microprocessor 28 accesses data from the external memory 36 through the microprocessor's receive RX and transmit TX ports, P10 and P11, respectively.

The preferred embodiment utilizes a Dallas Semi-Conductor Touch Memory DS 1993. The touch memory is a two-wire reusable device that is environment insensitive which is especially necessary in the automobile industry where automobiles are left outside in extreme weather. Because of its ability to read and write to memory with only a two wire connection, the “contact” problems normally created by dirt, dust and other impurities are greatly reduced. Also, problems associated with multiple insertion devices, such as connectors, are minimized due to the reduced number of connections. The touch memory is also rugged and thus impervious to handling abuses by the dealer who will, most likely, be inserting and removing the touch memories into and out of the playback unit 10. While other transportable memory devices such as floppy disks, CD ROMs, and computer memory chips, can be utilized in the present invention, these memory storage technologies are read by devices with moving parts which are expensive and not as reliable as the touch memory devices. Also, semiconductor devices and similar devices that do not require readers with moving parts, are very sensitive to handling and not designed to be transported in an application such as the present invention. The touch memory provides the best all around performance.

A speech processor 38 is also located on the printed circuit board 12. A TSP 53C30, manufactured by Texas Instruments, is used to convert digital input, concatenated by the microprocessor 28 using the internal and external memories, to an analog signal for transmission through the speaker 14. The microprocessor 28 controls the speech processor 38 via the data bus 34 and the address bus 35. The speech processor 38 outputs the signal to a filter U11 42. The signal is then transmitted through an amplifier U15 40 to amplify the analog signal prior to transmission through the speaker 14.

Other various components such as latching inverters, capacitors, transistors, regulators, crystals and resistors are utilized by the playback unit 10, their use is easily understood by a person having ordinary skill in the art and is thus not further described in this specification.

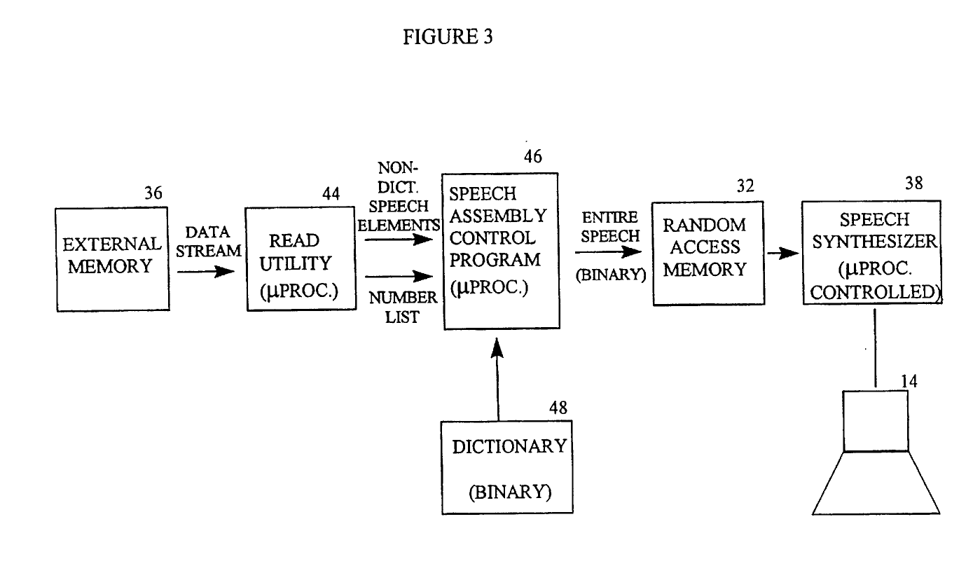

FIG. 3 shows the functional block diagram of the audio playback unit 10. In order for a dealer to be able use an audio playback unit 10 in an automobile he is attempting to sell, a replaceable memory 36 must be programmed for that particular automobile. The replaceable memory 36 provides information to the microprocessor 28 pertaining to which elements from the element list, located in the internal memory 30 and, in some cases, the external memory 36, will be used, and in what order. The external memory 36 download routine is described below.

Once placed in an audio playback unit 10, a read utility 44 extracts data from the external memory 36. A speech assembly control program 46 then concatenates elements from the element list or dictionary 48, residing in the internal memory 30, along with the non-dictionary elements retrieved from the external memory 36, if any, and loads the internal RAM memory 32 with the concatenated binary message. The binary message is then converted to an analog signal in the speech processor 38 before being audibly transmitted through the speaker 14 to the prospective purchaser. The microprocessor program is attached as part of Microfiche Appendix.

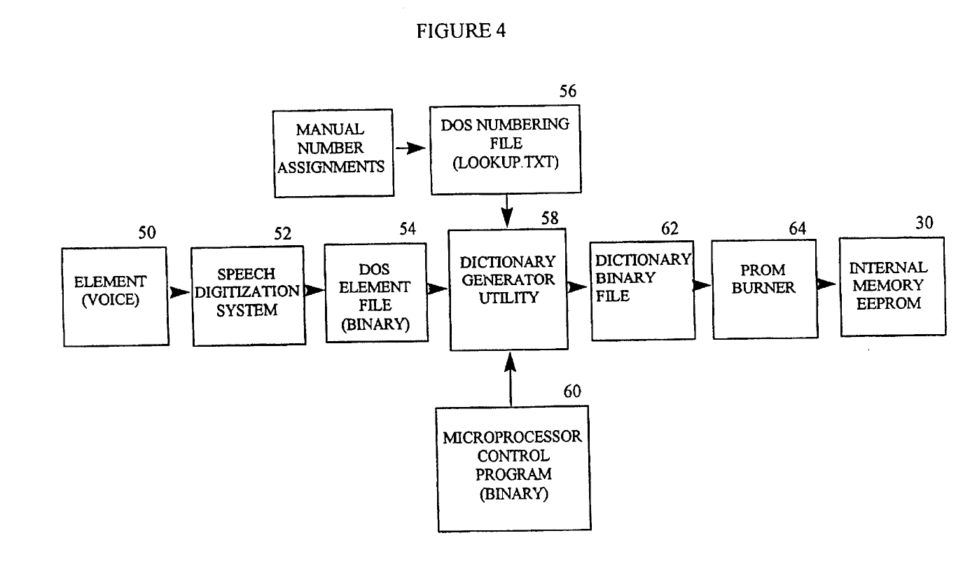

The internal memory contains three separate groupings of data: the microprocessor control program (control program); the individual speech elements (elements); and the table which contains the location (or address) of the individual speech elements in the internal memory (table). The combination of the Table and the Elements is referred to as “the dictionary”. FIG. 4 shows the functional block diagram of the routine which downloads these data groups into the internal memory 30. As described in detail elsewhere, these three groupings work together to create the message to be delivered to the prospect. The control program uses the table to locate the proper elements for assembly into the message. The internal memory download routines are attached as part of the Microfiche Appendix.

To create the internal memory element grouping, an element 50 (tape recorded voice) is digitized using a speech digitization system 52, the SDS 5000 manufactured by Texas Instruments, to create a DOS element file 54. The digitization process used in the preferred embodiment is Linear Predictive Coding (LPC), however, other types of speech synthesis exist. The desired speech is captured, either on high quality tape where it is transferred to an electronic system, or directly by the electronic system. In either case, the captured speech is converted into electronic codes and separated into groups of data, speech elements, which are individually stored for future analysis.

Each element file 54 is assigned an identifying tag which is recorded in the DOS numbering file (LOOKUP.TXT) 56. The dictionary generator utility 58 converts the DOS numbering file 56 into the table of locations which it then combines with the microprocessor control program 60 with the DOS element files 54 to create a dictionary binary file 62. The dictionary binary file is “burned” into the internal memory 30 using a PROM burner 64 resulting in an internal memory 30 containing a dictionary and the microprocessor control code 60.

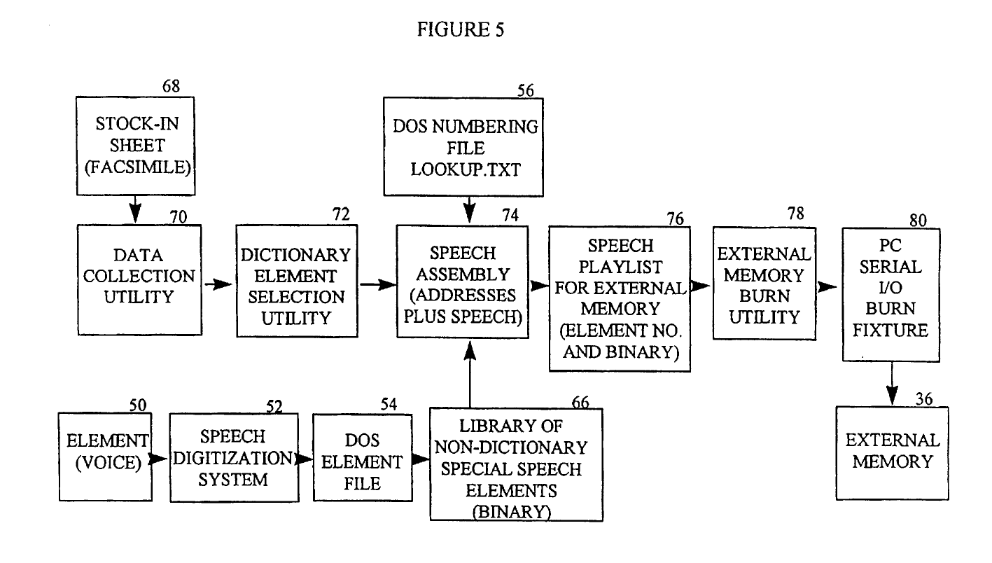

FIG. 5 shows the functional block diagram for programming the external memory 36. The external memory download routines are attached as part of the Microfiche Appendix. After being programmed, the external memory 36 contains information which will allow the microprocessor to select elements from the element list located in the internal memory 30. The external memory 36, however, may contain non-dictionary elements 66, or elements not previously stored in the element list in the internal memory 30. These non-dictionary elements 66 are also created using the speech digitization process described above. For example, Dealer's Names and Dealer's Special Messages may be non-dictionary elements 66.

The automobile dealer transmits information pertaining to the automobile to be sold to a service center, or somewhere where the capability exists to create replaceable memories 36. This can be accomplished by sending a facsimile transmission of the stock-in sheet 68 pertaining to the automobile for sale which is entered into a data collection utility 70 by an operator. Although a remote service center is used in the preferred embodiment of the present invention, a service center may be located at the dealership where the automobile to be sold is located.

A dictionary element selection utility program 72 operates on the data received from the data collection utility 70 using a set of conditional rules to identify the correct elements which will be selected for speech, creating element numbers. A speech assembly utility program 74, using the same DOS numbering file 56, assembles the element numbers with any non-dictionary speech elements 66 to create a speech playlist 76. An external memory burn utility program 78 then programs the external memory 36 through a pc serial burn fixture 80.

There are many ways the dealer can transmit information to the service center. The preferred embodiment, however, utilizes a facsimile transmission of the automobile's “stock-in” sheet from the dealer selling the automobile to the service center. Instead of the stock-in sheet, a survey of the necessary information can be used. In another embodiment, the dealer sends the information pertaining to the automobile to be sold to the service center via facsimile. The service center then converts the information as described above and downloads the information into the playback unit through a modem, thereby removing the need for an external memory 36.

Once the replaceable memory 36 is programmed with the data pertaining to the automobile to be sold, the replaceable memory 36 is sent to the dealer. The dealer then inserts the replaceable memory into an audio playback unit 10. The playback unit 10 is placed into the automobile to be sold and the power plug 22 is placed into the cigarette lighter. The control panel 16 is placed on the window 18 such that the speaker 14 and control 20 are exposed to any prospective purchaser. When a prospective purchaser activates the control 20, the playback unit 10 transmits the message pertaining to the automobile to be sold through the speaker 14.

As described above, the external memory 36 provides the element numbers which, when used with a table in the internal memory 30, point to an address in the internal memory 30 where the desired element resides. The element number, however, may also point to an address located, instead, in the external memory 36. The located element is transferred into the internal RAM memory 32 and the program returns to read the next element number in the external memory 36. This routine continues until each element number in the external memory 36 has been accessed and every element has been transferred into the internal RAM memory 32. The microprocessor program then transfers the elements in the internal RAM memory 32 to the speech processor 38 where the message is converted from a digital signal to an analog signal to be audibly transmitted through the speaker 14 to the prospective purchaser.

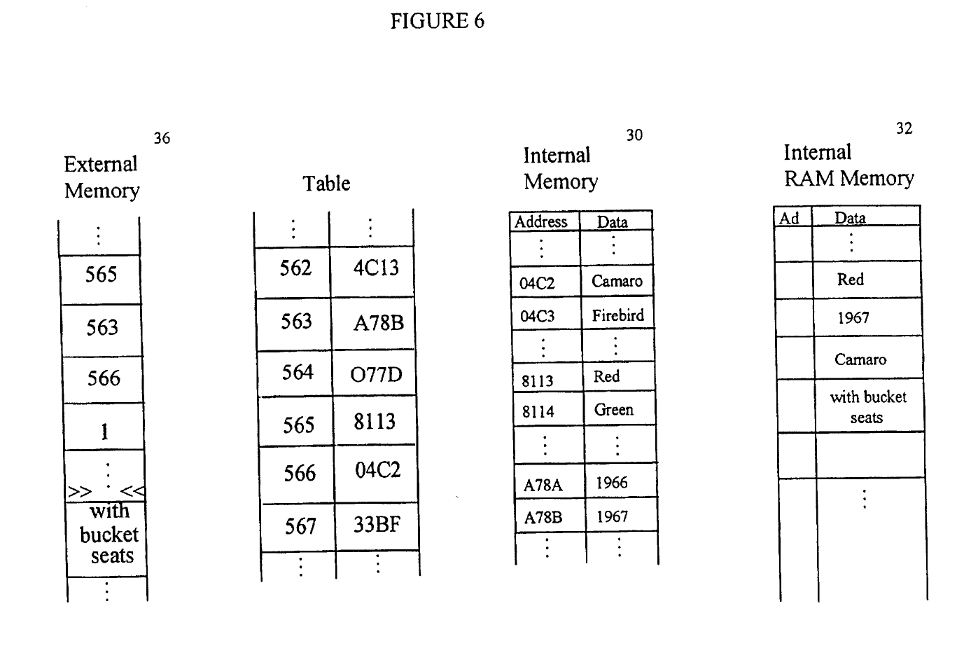

FIG. 6 represents the internal memory 30, the internal RAM memory 32, and the external memory 36. The actual data residing in each of these memories are binary digits (BITs), however, for representative purposes, alphanumeric symbols are used.

The microprocessor 28, using the microprocessor program located in the internal memory 30, reads the element number (565) from the external memory 36. The element number uses a table located in the internal memory 30 to identify a location (8113) in the internal memory 30, where the speech element (RED) is located. The speech element is then loaded sequentially into the internal RAM memory 32. For element numbers below 256, the program loads a speech element into the internal RAM memory 32 from the external memory 36. The program routine repeats this sequence until all of the element numbers have been read from the external memory 36 and all of the elements have been loaded into the internal RAM memory 32. When the internal RAM memory 32 transmits the sequentially ordered elements through the speech processor 38, the message “red 1967 Camaro with bucket seats” will be audibly transmitted to the prospective purchaser through the speaker 14.

To create a speech element to be stored in the external or internal memories, human voice is converted into 50 electronic samples per second or 20 msec samples. Each speech element is made up of at least one and usually multiple 20 msec samples. The number of samples per second determines the ability of the playback unit to recreate the human voice. Increasing the number of samples improves the quality.

The converted information is then stored in the internal and external memories to be played back as part of, or for the entire message to a prospective purchaser. The message transmitted to the prospective purchaser is made up of at least one and usually multiple speech elements. As describe above, elements stored in the internal memory 30 are stored during the manufacture of the playback unit, while elements stored in the external memory 36, if any, are stored during the programming of the external memory 36 for a particular automobile to be sold.

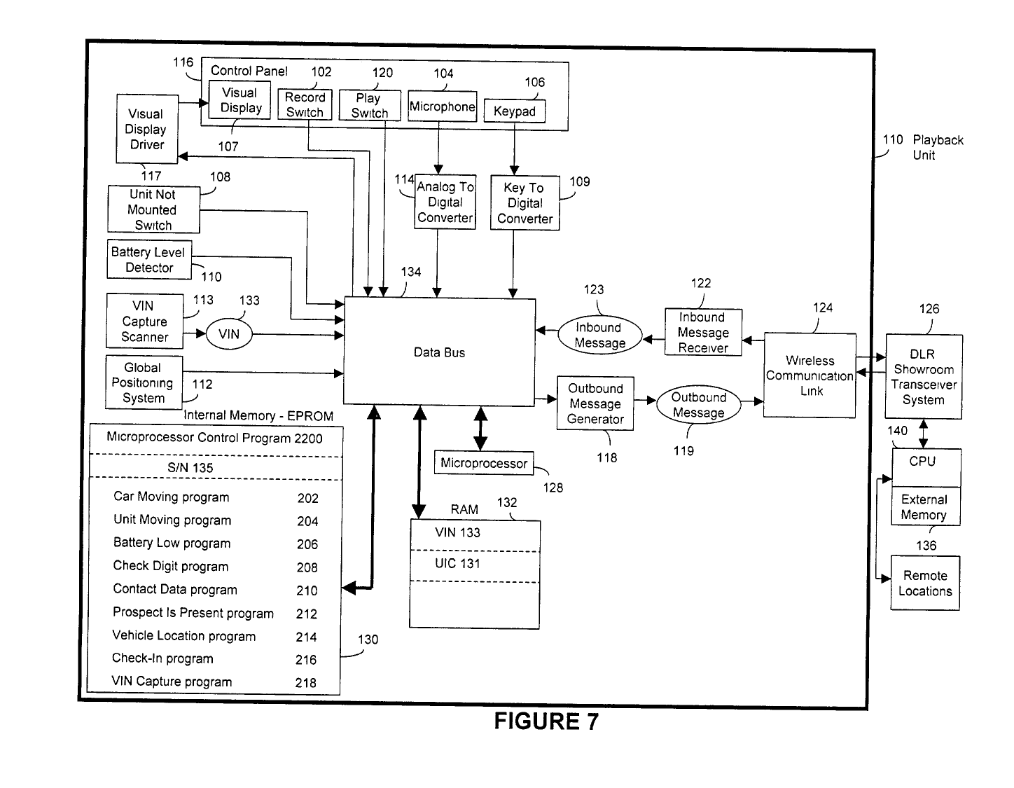

FIG. 7 illustrates an alternate embodiment of the present invention. Wireless Communication Link 124 and the companion DLR Showroom Transceiver System 126 provide a bi-directional capability which enables a set of playback unit 110 features which provide the automobile dealer with additional operational functions. For example, data inbound to the playback unit 110 can be automatically downloaded, either from dealer's CPU 140 or from remote locations. This function allows the dealer to edit messages intended for the prospective purchaser without having to move the data manually to the desired playback unit 110. As a further example, the dealer now has an automated pathway for sending control information to playback unit 110, such as commands to respond with status messages, maintenance messages or security messages. Also, it is more convenient for the dealer to combine remotely located auxiliary data such as Internet information with the data sent to playback unit 110 intended for presentation to a prospective purchaser.

To accomplish these, and other functions, in the preferred embodiment External Memory 136, located in CPU 140, is used to assemble the message elements for the message to be delivered to the prospective purchaser. External Memory 136 is downloaded, under control of CPU 140 into Dealer Showroom Transceiver System (DLR) 126 and then transmitted to Wireless Communication Link 124. Microprocessor 128, driven by Microprocessor Control Program 200, causes Wireless Communication Link 124 to download, first to Inbound Message Receiver 122 and then, via Data Bus 134, to RAM 132.

In a similar manner, command information, when required, is downloaded from DLR CPU 140 to RAM 132. (Although the message data and command information can originate or terminate in locations remote from CPU 140 and also be transmitted directly to Playback Unit Wireless Communication Link 124 from these remote locations, for purposes of clarity, the following discussion will assume that CPU 140 is the source and destination of all remote communications with playback unit 110).

Because the wireless communication is bi-directional, the dealer can receive a set of messages from playback unit 110, for example, a message containing the name and/or phone number of the prospective purchaser, or messages about the location and use of the vehicle for sale or messages requesting maintenance due to low battery or due to problems in delivering the presentation to prospective purchaser. To achieve the transmission from playback unit 110 to CPU 140, under control of microprocessor 128 and microprocessor control program 200, information is uploaded from RAM 132 via data bus 134 to Outbound Message Generator 118, where the message is checked for accuracy and formatted so as to be compatible with Wireless Communication Link 124. It is then transmitted to DLR Showroom Transceiver System 126 and then routed to CPU 140 for processing by one or more of the following methods; decoding, deciphering, printing, displaying and/or extracting.

FIG. 7 also shows the Internal Memory—EPROM 130 (EPROM), previously described generally in discussion of FIGS. 2A, 2B, 2C and 2D above, which contains microprocessor Control program 200 which drives microprocessor 128 while managing both inbound and outbound communications and EPROM 130 also contains one or more of a group of special function programs, including, but not limited to Car Moving program 202, Unit Moving program 204, Battery Low program 206, Check Digit program 208, Contact Data program 210, Prospect-is-Present program 212, Vehicle Location program 214, Check-In program 216 and VIN Capture program 218. Each of these programs control one or more of the functions performed by playback unit 110. EPROM 130 may also contain S/N 135, a serial-number type code, unique for each playback unit 110 and assigned to each playback unit 110 at manufacture so that any particular playback unit can be differentiated from any other particular playback unit.

The present invention further utilizes an automated method to collect contact information, such as name and phone, from any prospective purchaser so that, when a prospective purchaser visits the automobile car lot for example when the car lot is closed, as is often the case, the dealer will know who was interested in information on a particular vehicle. This information, particularly useful for sales and marketing purposes, can be collected in many ways such as by a microphone (voice message), keypad or other automated recording means, all located within the playback unit.

Additionally, as described previously, when the prospective purchaser wishes to receive a message about an automobile, he activates the control switch mounted on the control panel. The methods of message delivery to the prospective purchaser include, among others, audio output, described previously, and image output on a visible display screen located on the control panel. Details follow of the implementation of these and other functions.

Control Panel 116 of the playback unit 110 contains Play Switch 120, Record Switch 102, Microphone 104, Keypad 106 and Visual Display 107, each mounted so that it is accessible to the prospective purchaser of the automobile. Additionally, mounted within playback unit 110 are electronic circuit modules which perform one or more of the functions of playback unit 110. These modules include, but are not limited to, Visual Display Driver 117, VIN Capture Scanner module 113, Battery Level Detector module 110, Global Positioning System 112, Unit-Mounted Switch module 108, Analog-to-Digital Converter module 114 and Key-to-Digital Converter module 109.

FIG. 7 also shows the Dealer Showroom Transceiver System 126 (DLR), Dealer CPU 140 (CPU), External Memory 136 (shown contained within CPU 140), and Internet or Network Links to Remote Locations.

The functions that playback unit 110 perform include, but are not limited to, sending messages to CPU 140, receiving messages from CPU 140, providing information to a prospective purchaser or collecting data from a prospective purchaser.

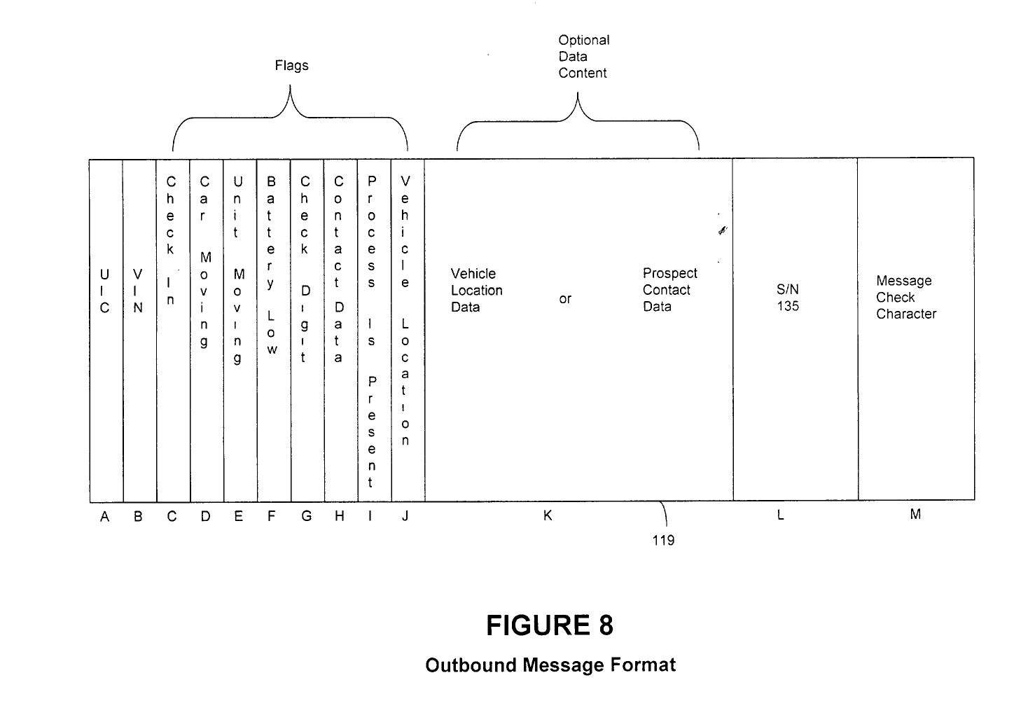

FIG. 8 shows the preferred embodiment of the format for Outbound Message 119 which playback unit 110 sends to CPU 140. The data, which is assembled in RAM 132, is transferred to Outbound Message Generator 118 via Data Bus 134. Outbound Message Generator 118 formats the data into Outbound Message 119 and transfers it to Wireless Communication Link 124.

Since the format of Outbound Message 119 is controlled by microprocessor 128, it can be reprogrammed to suit operational needs. The format of a typical Outbound Message 119 of the present embodiment is shown in FIG. 8. In the preferred embodiment, Message Segment L contains the value of S/N 135 which microprocessor 128 extracts from EPROM 130 and transferred to RAM 132 for message assembly. As described previously, the S/N 135 may not necessarily be included in the present invention.

Message Segment B contains VIN 133 and a check character for VIN 133. VIN 133 is captured either by scanning it from the name plate data on the automobile using VIN Capture Scanner 113, or by key entry via Keypad 106, located on Control Panel 116. In either case, the capture function is managed by microprocessor 128 under control of VIN Capture program 218. As with the S/N 135, the VIN 133 may not be necessary to implement the functions of the present invention.

Message Segment C through message Segment J contain flags whose value is either numeral 0 representing “not present” or numeral 1, representing “present”. Table 1 lists the meaning assigned to each flag.

TABLE 1

| Segment | PRESENT | NOT PRESENT |
|---|---|---|
| C | Vehicle is present on car lot. | N/A |
| D | Location Data has changed since | Location Data unchanged. |
| | last reading. | |
| E | Playback Unit has been removed | Playback Unit Stationary |
| | from vehicle. | |
| F | Battery Low; Service required. | Battery level acceptable |
| G | Check Digit error in last inbound | Last inbound message |
| | message. | received correctly. |
| H | Prospect contact information is | No contact information |
| | in Segment K. | |
| I | Prospect presently receiving | No message being |
| | message; Send salesperson. | delivered. |
| J | Vehicle location information is | No location information |
| | in Segment K. | |

The contents of Segment K depend on flags H and J. If Flag H is “present”, then Segment K contains Vehicle Location Data. If Flag J is “present”, then Segment K contains Prospect Contact Data. If neither flag H nor Flag J is “present”, Segment K contains no data. As will be seen from the following discussion, both flags will not be “present” at the same time.

Segment M contains a Message Check Character which is calculated by microprocessor 130 under control of program Check Digit 208. This character is used by DLR 126 to ensure an accurate message reception.

The following discussion details how each of outbound message flags, located in Segment C through Segment J, is generated. As described above, messages from CPU 140 to playback unit 110 are either created in CPU 140 or routed through CPU 140 from remote locations. These messages are of at least two types: type 1 messages contain command information to cause playback unit 110 to undertake a certain action, such as to “report in”, i.e., initiate an outbound message; type 2 messages contain information to be assembled for presentation to a prospective purchaser.

An example of a command type 1 “report in” message would be a request from CPU 140 to a particular playback unit asking for a check-in response. Wireless Communication Link 124 receives this message and routes it to Inbound Message System 122. Inbound Message System 122 deciphers the incoming data, insures that the UIC is correct, checks the communication accuracy, and sends on to microprocessor 128 an inbound message 123, which alerts the microprocessor to the “check-in” request. Microprocessor 128, under control of Check-In program 216, sets Check-In flag, stored in Segment C, in RAM 132, to “present” and then initiates the particular process to send the appropriate message, described above, to CPU 140. In much the same manner, CPU 140 (or a remote location) can address any particular playback unit and, by sending a type 1 message, command that particular unit to respond. Examples of playback unit responses to type 1 command messages include “vehicle location”, or “VIN” or “UIC identification” messages.

Type 2 messages from CPU 140 to playback unit 110 contain data that is intended to be stored and compiled for presentation to a prospective purchaser. Such information might originate, as described previously, at a service center. Alternatively, it might originate at a remote location, reaching CPU 140 via Internet, Local Area Network, or other type of communication system. Referring to FIG. 7, this information is stored, as described previously, in external memory 136. It is downloaded to playback unit 110 during initial setup, when the message to be presented to prospective purchaser is first loaded into playback unit 110. It is also downloaded when a message from playback unit 110 indicates that, due to corruption of data held in RAM 132, reloading of the information is required, or when the dealer changes the source information, such as vehicle price change, financing terms, or the like.

Type 2 messages are routed from CPU 140 to DLR 126 where, similar to type 1 messages, they are transmitted to Wireless Communication Link 124, and sent on to Inbound Message System 122. Unlike type 1 messages, however, the information in type 2 messages is converted into Inbound Message 123 and then stored in RAM 132 until required by microprocessor 128 for presentation to prospective purchaser.

When the prospective purchaser depresses Play Switch 120 mounted on Control Panel 116, microprocessor 128, under control of the microprocessor control program 200, which program 200 is located in internal EPROM memory 130, assembles the data if such assembly is necessary for the prospective purchaser presentation message from various locations in RAM 132, the data having been stored there, as described above, during uploading of a type 2 message from CPU 140. Next, microprocessor 128, under control of Check Digit program 210, performs a check digit calculation. This calculation, a type used throughout the computer industry, insures that the data present in RAM 132 is accurate. If the check digit calculation indicates that data in RAM 132 is corrupted, microprocessor 128 sets the Check Digit flag in message Segment G to “present” and causes an Outbound Message 119 to be sent to CPU 140. When received and extracted at CPU 140, the check digit “present” flag alerts the dealer at CPU 140 to re-send the type 2 message from External Memory 136 so that playback unit 110 can replace the inaccurate presentation data, currently stored in RAM 123, with fresh presentation data.

When the result of the check digit calculation indicates that the data present in RAM 132 is accurate, microprocessor 128, directed by Microprocessor Control program 200 causes the presentation data in RAM 132 to be routed to Visual Display Driver 117 via Data Bus 134. Visual Display Driver 117 formats the data in a manner compatible with Visual Display 107, mounted as described above, on Control Panel 116. Visual Display 107, may be a Light Emitting Diode (LED) array, of the variety frequently found in cellular telephones and hand-held computing devices, such LED arrays and their companion drivers well known to a person skilled in the art. The prospective purchaser can control the visible presentation, moving either forward (skip) or backward (repeat) by using keys on Keypad 106, which keys are marked for this purpose.

Concurrently with the message presentation described above, microprocessor 128, under control of Prospect-is-Present program 212, constructs a Prospect-is-Present (PIP) message by setting the PIP flag stored in Segment I in RAM 132 to “present” and, as previously described, sends an Outbound Message 119 to CPU 140. This Outbound Message 119 contains UIC 131 data in Segment A and Location Data in Segment K. UIC 131 and Location data are each extracted from the received wireless message at dealer's CPU 140 and used to alert the sales manager that a message is presently being played by the playback unit 110 containing UIC 131. The sales manager consults his UIC index, a list assigning each UIC 131 to a corresponding vehicle, and, using the extracted location data, dispatches a salesperson to the particular vehicle indicated in the UIC 131 index.

A prospective purchaser, visiting the car lot during after-hours, may desire to leave his/her name and phone number. For this purpose, Record Switch 102, Microphone 104 and Keypad 106 are mounted on Control Panel 116. The prospective purchaser depresses Record Switch 102 and either speaks into Microphone 104 or keys the contact information into Keypad 106 or both. Output signals from Keypad 106, a conventional membrane keypad, are processed by Key-to-Digital Converter 109 to create digital data. Analog output signals from Microphone 104, a conventional miniature microphone similar to those used in Cellular telephones, is converted and formatted by Analog-to-Digital Speech Processor 114 into digital data. Microprocessor 128, under control of Contact Data program 210, senses the activation of Record Switch 102, stores available digital data from Key-to-Digital Converter 109 and/or Analog-to-Digital Speech Processor 114 in RAM 132, sets the Contact Data flag in Segment H to “present”, loads Outbound Message Generator 118 from RAM 132 via Data Bus 134 and, as described above, causes Outbound Message Generator 118 to send Outbound Message 119 to CPU 140. The Contact Data is extracted from the received message at CPU 140 and subsequently used by the dealer to contact the prospective purchaser.

The present invention provides a method for playback unit 110 to report its own current location. This is accomplished by incorporating a Global Positioning System (GPS) in the playback unit. The GPS system works by electronically determining its own location using signals continuously broadcast from a series of 24 orbiting satellites. In the present invention, the location data from the GPS is monitored by the playback unit microprocessor under control of Vehicle Location program 214 stored in EPROM 130. Every few minutes, microprocessor 128 causes GPS 112 to transfer location data to RAM 132 via Data Bus 134. The most recent reading replaces the prior reading, ensuring current location data.

Following each location data transfer to RAM 132, microprocessor 128 transfers the location data to message Segment K, changes the value of the Vehicle Location flag, located in message Segment J, to “present”, loads Outbound Message Generator 118 from RAM 132 via Data Bus 134 and, as described above, causes Outbound Message Generator 118 to send Outbound Message 119 to CPU 140. When the message is received at CPU 140, location data and UIC 131 are extracted, so that the dealer can determine the location on the car lot where the vehicle is parked.

For security purposes, sales purposes or inventory monitoring purposes, the dealer would like to know when the vehicle is moved from the current parked position. This information is provided by playback unit 110 which compares current location data reading with prior location data reading. When the difference between the two readings is non-zero, the vehicle is moving. In the event that the vehicle is moving, microprocessor 128 sets Car Moving flag located in message segment D to “present” before sending the message as described above. This Car Moving flag, when detected at CPU 140, alerts dealer that vehicle is moving around the lot or that it has been driven off of the lot.

The GPS location data message, as described, is transmitted every few minutes. As such, it can be used for security purposes or for maintenance purposes. For example, if the vehicle were stolen with playback unit 110 mounted, the location data would indicate that the vehicle had left the car lot. If playback unit 110 is removed from the vehicle and left behind, the Unit-Not-Mounted Switch 108 is immediately activated. Activating Unit-Not-Mounted Switch 108 triggers microprocessor 128 and activates Unit Moving program 204, stored in EPROM 130, causing microprocessor 128 to set the value of Unit Moving flag stored in message Segment E to “present”, load Outbound Message Generator 118 from RAM 132 via Data Bus 134 and, as described above, cause Outbound Message Generator 118 to send Outbound Message 119 to CPU 140. This Unit Moving flag, when detected at CPU 140, alerts dealer that the box has been removed from the vehicle whose UIC 131 is entered into message Segment A.

FIG. 2c illustrates a 12 volt power source for playback unit 110. Battery Level Detector 111 monitors the level of the power supply. When it drops below a preset level (usually about 9 volts), Battery Level Detector 11 sends a signal to microprocessor 128 which launches Battery Low program 206 causing microprocessor 128 to set Battery Low flag in message Segment F to “present”, load Outbound Message Generator 118 from RAM 132 via Data Bus 134 and, as described above, cause Outbound Message Generator 118 to send Outbound Message 119 to CPU 140.

In another embodiment of the present invention, Referring to FIG. 7, playback unit 110 captures VIN 133, inserts it into Outbound Message 119 and transmits it directly to a remote “resolution server” via Wireless Communication Link 124. The resolution server constructs a URL from VIN 133, accesses that address on the Internet, and the Web Site at the chosen URL returns the complete presentation message to playback unit 110.

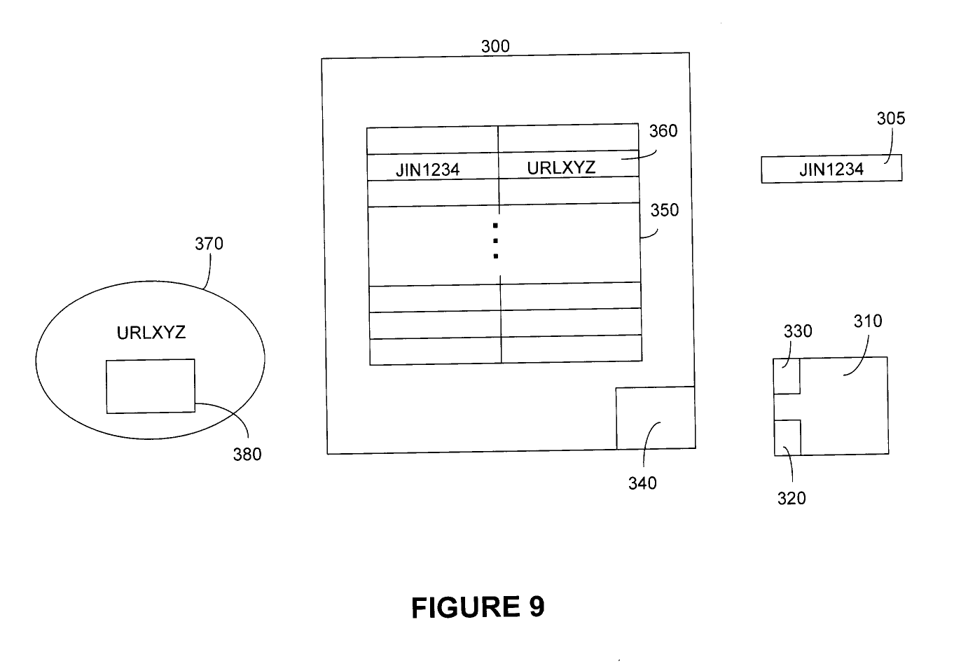

In an alternative embodiment of the present invention, a dealer or a service uses a database or switch to send a message to a prospective purchaser that has its own playback unit. FIG. 9 shows a structure 300 whereby a prospective purchaser uses a playback unit 310 in conjunction with the VIN 305 of an automobile offered for sale (not shown) to obtain information about the automobile for sale. The playback unit 310 can be a personal digital assistant (PDA), a cellular telephone, a handheld computer, a laptop computer, etc. The playback unit 310 has, in addition to a CPU and memory which are found on these types of units, an input device 320, such as a keyboard, scanner, character recognition capabilities, microphone, etc., such that the VIN can be entered into the playback unit 310.

The playback unit 310 must also contain wireless receiver/transmitter capabilities 330 such that the playback unit 310 can send a wireless signal to the system 300 and receive a wireless signal from the system 300. As such, the system 300 must also have wireless receiver/transmitter capabilities 340. The system also contains a database or switch 350 which has been populated with particular VIN 305 and their associated URL's 360. Each URL 360 further corresponds to a location on the Internet 370 where information 380 pertaining to the particular automobile for sale has been stored by the dealer or a service. The information 380 can be the number of miles the automobile has been driven, the year the automobile was manufactured, or any other information 380 pertaining to the automobile.

In use, the prospective purchaser with his own playback unit 310 approaches an automobile that is for sale. The purchaser uses the scanner 320 on the playback unit 310 to scan the VIN 305 into the playback unit 310.

The playback unit then sends a VIN message, in this case JIN1234, to the system 300 through the transmitter 330 and then system receiver 340. The system 300 then finds the corresponding URL 360, in this case URLXYZ, and retrieves the information 380 from the URL location on the Internet 370.

The referenced information 380 is then sent to the playback unit 310 for storage, retrieval, viewing, etc., by the prospective purchaser.

The algorithms and instructions disclosed, along with the mechanical and electrical arrangements are but embodiments of the invention. Other mechanical and electrical arrangements, other logical routines and subroutines are possible and are to be included in the invention and are not meant to limit the scope of the invention.

We claim:

1. A playback unit for providing information pertaining to an automobile for sale to prospective purchasers comprising:
a microprocessor;
a semiconductor memory containing element numbers and speech elements, said memory coupled to said microprocessor;
a speech synthesizer coupled to said microprocessor, said speech synthesizer controlled by said microprocessor;
an audible output device, said output device coupled to said speech synthesizer;
a switch, said switch coupled to said microprocessor for activating said microprocessor;
a microphone, said microphone connected to said microprocessor such that said prospective purchaser has the ability to leave a message in the playback unit; and
a power supply coupled to said microprocessor, said power supply providing power to said microprocessor such that when said switch is activated, said microprocessor retrieves element numbers from said replaceable memory and, depending on said element numbers, transfers said speech elements stored in said second memory through said output device.
